(19) United States
(12) Patent Application Publication
(10) Pub. No.: US 2018/0308069 A1
(43) Pub. Date: Oct. 25, 2018

(54) APPARATUS, METHOD, AND PRODUCT OF MANUFACTURE FOR ROBOT SERVICING

(71) Applicant: Garrick Edward STARKS, Charlestown, WV (US)

(72) Inventor: Garrick Edward STARKS, Charlestown, WV (US)

(21) Appl. No.: 15/956,175

(22) Filed: Apr. 18, 2018

Related U.S. Application Data
(60) Provisional application No. 62/487,139, filed on Apr. 19, 2017.

(51) Int. Cl. G06Q 10/00; G06Q 10/06

(52) U.S. Cl. CPC G06Q 10/20; G06Q 10/06314; G06Q 10/063116

(57) ABSTRACT

A method and system of a vehicle service. Such a method and system are related to computer-assisted software for summoning servicing of a vehicle. With the software, a customer and mechanics may communicate each other to offer and accept proper vehicle services.

### CROSS REFERENCE TO RELATED APPLICATIONS

This application claims priority from U.S. Provisional Patent Application Ser. No. 62/487,139, filed Apr. 19, 2017, the entire contents of which are hereby incorporated by reference.

### BACKGROUND

Frequently, individuals struggle with obtaining servicing of their vehicles or robots, whether they are stuck on the roadside or outside their own home. They often must drive to the point of sale to obtain oil and other automotive services. Alternatively, they must call other roadside services, where it is often difficult to reach an individual. Also, currently, people may experience the inconvenience of physically bringing their automobile to the point of service. This often requires further inconveniences such as leaving children alone, leaving work, or arranging for a telecommuting location. The entire process may become frustrating, tiresome, and inefficient for customers. Therefore, there exists a need for a tool that efficiently brings automotive services to the customer or automatically transports the customer's vehicle to the point of sale or service.

### SUMMARY

According to at least one exemplary embodiment, a method, product of manufacture, or apparatus for vehicle or robot servicing is described. Such a method, product of manufacture, and apparatus is related to summoning services for a vehicle or robot. With the invention, a customer and maintainers may communicate each other to offer, accept, and conduct proper vehicle/robot services.

Such a method of servicing a vehicle or robot may include: actuating, by at least one of a customer or a plurality of maintainers, the invention via at least one of a smart device and computer; sending, by the customer, a service request by using the invention; receiving, by the one or a plurality of maintainers, a notification of the service request via the invention; sending, by the one or a plurality of maintainers, a proposal of services via the invention; choosing, by the customer, the proposal sent by at least one of the plurality of maintainers via the software application; and accepting, by the at least one chosen maintainer, the task of delivering service to a vehicle or robot via the invention.

In another exemplary embodiment, an invention for servicing a vehicle or robot may be described. Such an invention may include: The invention's being actuated by at least one of a customer or at least one of a plurality of maintainers via at least one of a smart device and computer, sending a service request for the customer, receiving a notification of the service request for the one or a plurality of maintainers, sending a proposal of services for the one or a plurality of maintainers, choosing the proposal sent by at least one of the plurality of maintainers for the customer, and accepting delivery of service for the vehicle or robot from the at least one chosen maintainer; and a back-up representative being put in contact with the customer with being responsive to a case that no maintainer sends the proposal or accepts to deliver vehicle or robot service for the customer within a pre-determined time.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

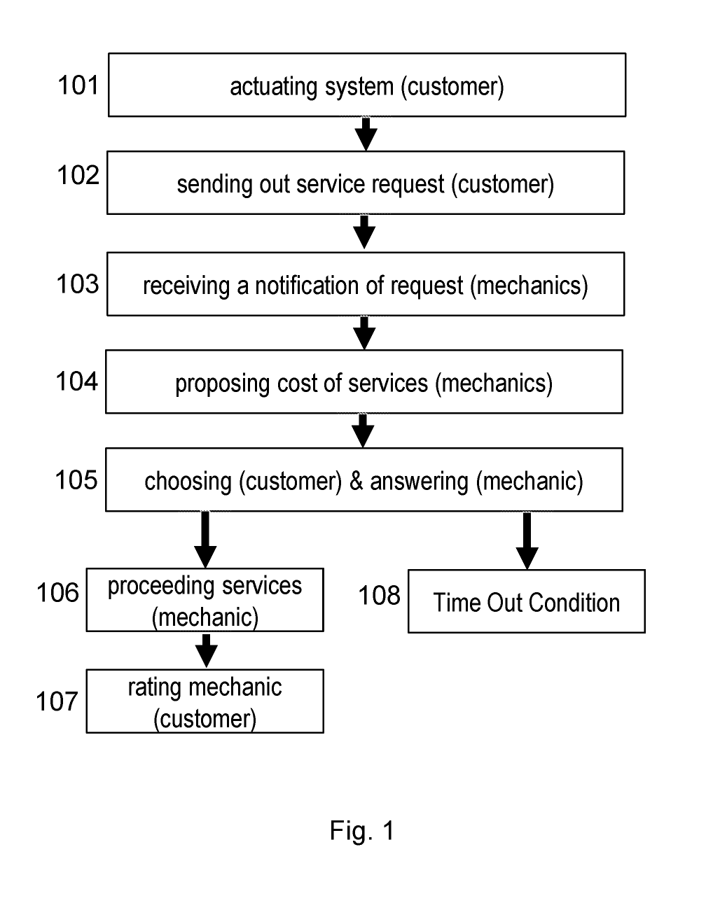

Exemplary FIG. 1 may show a process flow diagram of an exemplary embodiment of a method for summoning and dispatch of vehicle or robot services.

### DETAILED DESCRIPTION OF THE EMBODIMENTS

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Further, the sequence steps may vary in order of execution while retaining the same basic functionality of the invention. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

According to an exemplary embodiment, and referring to the FIGURE generally, a method, product of manufacture, or apparatus for servicing a vehicle or robot may be shown and described. In particular, such an invention may provide a way of summoning and dispatching vehicle or robot services. According to an exemplary embodiment, such a method may be embodied in one system or in a network of systems, for example a network of summoning and dispatching vehicle or robot services, as desired. Also, in an exemplary embodiment, the invention may be used for the summoning of services for a vehicle.

As previously stated, individuals struggle with obtaining services for their vehicles or robots, whether they experience a breakdown while driving that leaves them stranded on the roadside or outside their own home. They often must drive to the point of sale to obtain oil and other automotive services. Alternatively, they must call other roadside service providers, where it's often difficult to reach an individual. The entire process may become frustrating and tiresome for customers. Embodiments described herein provide a technical solution for these technical problems by providing a tool that summons and brings automotive services to the customer or automatically brings the vehicle or robot to the point of service.

According to an exemplary embodiment, the invention may describe a vehicle service providing a method that may use a computerized program or mobile application to perform summoning and dispatching of services to the vehicles, or to perform automatic navigation of a self-driving robot to the point of service for maintenance. In an exemplary embodiment, the vehicles to be serviced may include self-driving automobiles, flying cars, electric or hybrid vehicles, or gasoline and diesel-powered vehicles. The terms “robot” or “robotic” may include the following levels of control: fully autonomous, semi-autonomous, human supervisory control, swarm, tele-operation, or full manual control. “Robots” may also be mobile or stationary devices (e.g., legacy vehicles, self-driving vehicles, drones, stationary robots, factory robots, stationary road toll robots, etc.) A “service provider” or “maintainer” may be a human or a robot (i.e., a robot controlled either autonomously, semi-autonomously, through human supervisory control, swarm, tele-operation, manually, etc.).

Various exemplary embodiments may utilize computer readable media (i.e., products of manufacture), methods, or various types of apparatus, and the service provisioning invention may increase the convenience of acquiring and paying for maintenance services.

Turing now exemplary FIG. 1, the steps of providing vehicle service may be described. In accordance of an exemplary embodiment, reference numbers may depict: 101: the servicing system may be activated via a software or mobile application; 102: the system may send out service request in a predesignated radius around customer. According to an exemplary embodiment, when customer first registers for the system, the customer may input pertinent information into a registration form, so the customer does not have to enter it every time the system is used. (i.e., car maker, color, year, service desired, type of oil needed, and other information); 103: all mechanics who have signed up for the servicing system in radius of the call signal may receive a notification on their device telling them a request is available; and 104: estimated cost of services and itemization screen may appear on customer's device with proposed cost of services.

Referring still to exemplary FIG. 1, in accordance of an exemplary embodiment, reference numbers may depict: 105: if a customer chooses one of the proposals, a mechanic may either answer the call and drive to customer or decline to answer call. According to an exemplary embodiment, if a mechanic answers the call, the mechanic may push a “button” to tell the customer they are on the way. Also, in an exemplary embodiment, mapping software may tell the customer where the mechanic is and an estimated time of arrival. According to an exemplary embodiment, if the mechanic declines to answer the call, the customer's name goes into a queue until another mechanic answers and removes call; 106: the mechanic may show up at a vehicle's location, identify themselves, gain access to vehicle, and perform services. According to an exemplary embodiment, a driver's estimated time of arrival may be tracked by, for example, a GPS program (such as Google Maps or Waze). Also, tracking a self-driving vehicle or a drone may be accomplished by this method; and 107: the customer may rate the mechanic from one to five stars (or using any other scale, as desired). According to an exemplary embodiment, for the rating, logic gates may be used, but software program may also be used for the rating (such as certain computer readable media), depending on an embodiment.

Referring still to exemplary FIG. 1, in accordance of an exemplary embodiment, reference numbers may depict: 108: if there is a customer requesting service and no mechanic has responded within a pre-defined time (Time Out Condition), customer service may be automatically alerted and the customer can be put in contact with a representative. Back up drivers may be sent for the Time Out Condition. In an exemplary embodiment, there may be a time out method whereby, if a mechanic does not answer the query of a customer in a pre-defined time, an alternate response may be generated to satisfy the user's needs.

According to an exemplary embodiment, specially designed trucks may be used to provide service. Regarding oil changing service embodiments, such trucks may be designed to elevate the customer's vehicle like a car carrier to provide a safe and stable space below for the operator to change the oil without fear of the car falling on him or her. In an exemplary embodiment, the truck may also have a covering that protects the car and operator from the elements and may provide advertising space on its outer surface. According to an exemplary embodiment, opportunities for advertisements and up selling may also exist on the servicing system page for the customer to see and utilize.

According to an exemplary embodiment, the invention may be used to service self-driving vehicles both commercial and private (and may include trucks, taxis, flying cars, electric cars, all self-driving vehicles, or all fuel types, for example, solar, electric, natural gas, diesel, and gasoline powered legacy vehicles) that are summoned or dispatched for repair or maintenance services. Self-driving vehicles may utilize the following levels of control: fully autonomous, semi-autonomous, human supervisory control, swarm, tele-operation, or full manual control.

According to an exemplary embodiment, there may be a selection of one or more types of payment. In an exemplary embodiment, membership or non-membership types of payment may be used, for example iPay, Android pay, bitcoin, PayPal, subscription services, or any other suitable means of payment. As mentioned above, advertisements may appear on any screen in the app and may be visual or auditory.

According to another exemplary embodiment, drones may be summoned or dispatched for maintenance or repair. Also, in an exemplary embodiment, services may be summoned to robot/robotic delivery mechanisms, such as a food delivery robot. Alternatively, robots may be dispatched to retrieve or repair other vehicles or robots. Further, the robot or vehicle that may be dispatched to retrieve or repair other vehicles or robots may be designed to have a specialized space for an operator. For example, the service vehicle may be a car carrier that is modified to have an oil changing pit below the vehicle being serviced. Further, according to an embodiment, self-driving street sweepers or snow trucks may be summoned or dispatched for maintenance or repair.

According to an exemplary embodiment, the system may be used via a smart device. For example, the system may be utilized via a software application on a computer, laptop, table, phone, and the like.

Further, according to an exemplary embodiment, a maintenance service invention for robotic self-steering automated vehicles may be provided. In an exemplary embodiment, at least one calendar or database may be created and maintained in the invention. The at least one schedule database structure in which schedule data and other associated data may be stored, partitioned, and secured via tools including zero or more of: Passwords, PINs, biometrics, tokens, or combinations thereof. An optional recommended maintenance schedule may be established in the calendar or schedule database structure based on one or more of: manufacturer's recommended schedule, manufacturer's recalls, or some other preferred maintenance and servicing schedules. Also, in an exemplary embodiment, manual, interactive, or automatic self-diagnostics of a vehicle or robot that may require maintenance may be established. The recommended maintenance and servicing schedule may be stored in the schedule database structure. Further, the invention may establish communication with the robot self-diagnostics to automatically or manually discover conditions that require maintenance. The user may manage the scheduling data using management tasks which may be one or more of: Manually or automatically uploading, updating, and storing the manufacturer's suggested maintenance tasks; manually or automatically uploading, updating, and storing product recalls; manually or automatically uploading, updating, and storing problems from the robot's self-diagnostics; manually or automatically uploading, updating, and storing problems discovered by the user or maintainer; manually or automatically uploading, updating, and storing problems discovered in any other way; and to manually or automatically uploading updating, and storing dates, times, and locations in the schedule database structure for the maintenance to actually occur. According to an exemplary embodiment, a suggested maintenance may be communicated to a user via a user interface. The user interface may be provided via the user's phone or other computing device and may also permit a user to update the suggested maintenance tasks and to schedule dates and times for the maintenance to actually occur.

According to an exemplary embodiment, the user interface of the maintenance service system and method for robotic self-steering automated vehicles may further suggest locations for the maintenance event from either the user profile and/or other maintainers from a maintainer candidate list which, thereby, provides advertisement of those businesses. Both lists may, non-exhaustively, contain zero, one, or more of: Advertisements of those businesses, their discounts, their ratings, and their presence on an automatic refusal of service list that is maintained by the user. The user may select or enter, via the user interface, one or more candidate maintainers, then inquiries may be sent to maintainers as to available locations, times, available services, pricing, and other important issues and policies. (the pricing may include a surge pricing). If there are responses from one or more maintainers, the responses may be presented to the user via the user interface so that a maintainer and actual appointment time may be selected by the user. The selected one or more maintainers may be notified that their response is accepted, and maintainers that provided responses that were not accepted by the user may be notified that their responses are not accepted. If there are maintainers that provided responses but the user declined the responses by selecting one or more responses from the non-exhaustive list including: Assigning the particular service to another maintainer, actively declining the particular service, not accepting the particular service, or cancelling the particular service, the declined maintainers are automatically notified by the invention that their responses are not accepted. If there are maintainers who did not provide responses before the user finally selected the maintainers that will perform the maintenance, the outstanding inquiries to the non-responsive providers are rescinded by the invention. If there is a plurality of maintainer locations to be visited, thereby forming a schedule chain, the routes to each maintainer may be optimized via travelling salesman or other route planning algorithm, while accounting for available appointment times, before finalizing selections of appointment times in the schedule chain. According to an exemplary embodiment, appointment data which is recorded or updated in the calendar or database of the system may non-exhaustively include actual date and time or the appointment, location of the maintainer.

The invention may check the robot's fuel, charge, or energy level to see if there is enough on-board (and/or enough fueling/charging locations en route) to complete the rest of the schedule chain (including the return trip). If there isn't enough fuel, the invention may notify the user or the invention may schedule a refueling or recharging stop as the first maintenance in the schedule chain. After each stop on the schedule chain, the invention may further, check the robot's fuel, charge, or energy level to see if there is enough on-board (and/or enough fueling/charging locations en route) to complete the rest of the schedule chain, including the return trip; if there isn't enough fuel, the invention may schedule refueling or recharging stops along the way as maintenance stops in the schedule chain and may notify the user.

In an exemplary embodiment, in a case where the robotic self-steering automated vehicle is not capable of departing on its own or being manually driven for any reason such as an accident, a vehicle retrieval service may be notified to assist a user optionally via the user interface of the system. Alternatively, a mobile servicing unit may be notified to schedule delivery of service to the immobile robot. Upon approval of the user, via the user interface of the system may automatically communicate the appointment data to the user for the retrieval service to take the vehicle to the maintenance appointment. A mobile servicing unit may be dispatched. The invention may further include a communication path for further communication between the user and the robot retrieval service or mobile servicing unit, so that additional information may be provided for service, retrieval, or further assistance from police, fire, or ambulance services. Upon arrival of the robot at the appointment location, the user interface may notify the user of the arrival, and the maintainer may then receive the vehicle. Further, upon reception of the robot by the maintainer, the maintainer may be given temporary authority (subject to liens placed on the vehicle by the maintainer, which may extend the time of the temporary authority) to activate, repair, test, and drive the robot; a receipt documenting the reception event may be produced and recorded for the user to keep in a file provided by the invention. The maintainer may inform the user, via the user interface, of an estimate of the work to be done including more work that may be discovered, suggested, or upsold by maintainer. Then, the user may decide whether the work should be performed according to the estimate. If no work is to be performed, the car may be set to return to user or to go to the next appointment in the schedule chain. If any work is to be performed according to estimate, the user may provide an affirmative response to some or all itemized maintenance to be performed by the maintainer. The invention may also ask the user to indicate that undesired tasks are to be declined for this visit.

The maintainer may set a vehicle return date and time in the vehicle calendar or database of the invention. That calendar or database may be limited, partitioned, and secured. Note that the calendar or database may include completion status of maintenance tasks, the time and date for releasing the robot to leave the maintainer. The time may be set to an indefinite time if the maintainer decides to put a lien on vehicle for payment. If there is no lien on the vehicle and the vehicle is not in the process of repair, the user may cancel or reschedule any or all appointments in the schedule data and may call for the vehicle to immediately return. According to an exemplary embodiment, the user interface of the system may notify the user of the completion of the maintenance event, the scheduled time for vehicle departure from the maintainer, and calculated time for arrival (at the user's option, the vehicle may return to place it originally left to go to the appointment or may go to the user's location if the user's location has changed). The invention may notify user of robot status data including, non-exhaustively, one or more of: The current completion status of the maintenance tasks, the currently scheduled time for release of the robot and departure from the maintainer, the calculated time for arrival at the next destination. At user's option, the robot's return location may be set or updated to return to a place selected by the user, whether it is the user's home, workplace, phone's current GPS location, or any other user-selected location. Also, at a predetermined time before the departure, the vehicle may notify user that it is about to depart. The invention may also notify the user of the next location, estimated time of arrival at the next location. In an exemplary embodiment, at a scheduled departure time, the vehicle departs and its progress may be logged by the system so that the vehicle status may be tracked by the user via the user interface with regularly updated GPS mapping or other interface. If the robot is a stationary robot that needs to be transported back to its location, a robot transfer service may be dispatched to replace the robot. If the robot is a mobile robot, upon arrival at the next destination, the robot may look for available parking, notify the user that it has arrived, and display its location on map via GPS or other location service. Upon arrival at a return destination, the user interface or driverless vehicle itself may notify the user that the vehicle has arrived and display its precise location on map. In a case where parking is not available, the user interface or driverless vehicle itself may notify the user of the fact and request assistance or schedule a time and place to meet the user or to wait for the user.

Further, according an exemplary embodiment, Agile scheduling module such as Kanban or SCRUM may be used for the maintenance service system and method for robotic self-steering automated vehicles. The Agile scheduling module may be created and maintained after creating and maintaining the calendar or database. Also, by using the Agile scheduling module, the system may either automatically or manually schedule a maintenance event after discovering conditions that require maintenance. Further, the Agile scheduling module may be updated to reflect desired maintenance dates and times when the user updates the suggested maintenance tasks and schedules dates and times for the maintenance to actually occur. The Agile scheduling module and the calendar may also be updated with using all relevant appointment data, after the responses are presented to the user so that a maintainer and actual appointment time may be selected by the user and upon user selection of a maintainer and appointment time.

Additionally, according to an exemplary embodiment, the appointment data including actual date and appointment time and location of the maintainer which is initially recorded or updated in the Agile scheduling module may also be subsequently updated in the calendar or schedule database, once actual appointment dates have been supplied to the invention. Also, when the maintainer provides an estimate of the work to be done, including more work that may be discovered by maintainer, either the user or maintainer may also update the Agile scheduling module with any discovered maintenance issues. After the user provides an affirmative response to some or all itemized maintenance to be performed by the maintainer, and once the user affirms the work to be done, the maintainer may perform maintenance and update the Agile schedule module that the appointment was completed. In turn, the calendar or schedule database may be updated. Also, the maintainer may set the vehicle return date and time in the Agile schedule module, and the calendar or schedule database may be updated, now that dates and times have been supplied to the invention.

Further, according an exemplary embodiment, in a case where no response is sent from the maintainer to the user within a predetermined time, the user may be notified, via the user interface, that there were no responses and that other maintainers should be selected or entered, or the maintenance should be delayed until a maintainer is available. Also, after the selected one or more maintainers is notified that their response is accepted, the maintainer may be also notified whether any offered loaner vehicle is accepted.

According an exemplary embodiment, in a case where a robotic self-driving vehicle is capable of departing to the maintenance appointment on its own and vehicle retrieval service is not required, after the appointment data are recorded in the Agile scheduling module and the calendar (or schedule database), the system may calculate distance and travel time to the maintenance appointment and may calculate appropriate departure time for prompt arrival. Also, in an exemplary embodiment, at a predetermined amount of time ahead of departure time, the system may recalculate distance and travel time to the maintenance appointment to verify appropriate departure time for prompt arrival using updated data. If there is no possibility of prompt arrival, the system may notify the user via the user interface that there is not enough time to arrive on time and may allow the user to either reschedule, cancel, or to go ahead and travel to appointment. If prompt arrival is possible with the current traffic conditions, then, at a predetermined amount of time before actual vehicle departure, the user may be notified that the vehicle is about to depart and gives user opportunity to cancel appointment and/or reschedule. At the predetermined departure time, the user interface or the driverless vehicle itself to be maintained may notify the user of departure and the vehicle departs for the maintenance appointment. Also, if a local obstacle, such as the user's garage door, impedes departure or access, the user interface or the driverless vehicle itself may notify the user of that status. The vehicle's progress to appointment may be updated in the system so the user and maintainer may observe the tracked progress and appointment may be cancelled during travel to maintainer. If the appointment is cancelled during travel, the vehicle may return to the original location or may go to the user's current location if the location has changed during travel. If the owner's vehicle breaks down en route and is no longer capable of going to the maintainer on its own, the system may call a vehicle retrieval service to take the vehicle to the maintenance appointment. The system may communicate the appointment data to the retrieval service and communicate its break down and retrieval service status to the user and the maintainer. Either the user or maintainer may update the Agile scheduling module with any additional maintenance issues discovered. If appointment dates and/or times are supplied to the invention, it may update the calendar using those dates and the data from the agile scheduling module.

After the user provides an affirmative response to some or all itemized maintenance to be performed by the maintainer, the maintainer performs maintenance and updates the vehicle Agile schedule module that the appointment was completed.

According to an exemplary embodiment, if a self-driving automated loaner vehicle or robot has been requested by the user, the loaner vehicle may be sent to user in order to replace the vehicle that will be repaired. The loaner vehicle's travel progress may also be logged and make available for display to the user and the maintainer via user interfaces such as mapping modules. A photo of the loaner vehicle (or one of similar make, model, and color) may be sent to the user in order to aid in identification of the loaner vehicle when it arrives. Upon arrival of the loaner vehicle at user's location, the system may notify the user of the arrival. According an exemplary embodiment, the user's phone (or other computing device) may be further configured or programmed to provide the user an interface where the loaner car's lights and/or horn may be operated to provide further assistance in identifying the loaner car. Also, the user's phone (or other computing device) may be operated as a keyless entry device for the loaner vehicle. The loaner vehicle is also started by commands from the phone or computing device.

The invention is applicable to improve any and all vehicles/robots that are controlled either autonomously, semi-autonomously, through human supervisory control, tele-operation, manually, etc. Further, the invention may apply to vehicles/mobile robots/stationary robots using any and all modes of locomotion. Further, the invention may apply to robots such as Internet of Things (IoT) robots, and robots that may move other objects around or may themselves be retrieved. For example, wheeled robots, water borne robots (surface vehicles, foiling vehicles, hovercraft, subsurface vehicles, etc.), airborne vehicles (e.g., fixed wing, rotary wing, jet, vectored thrust, rocket, etc.), levitating robotic vehicles (e.g., magnetic levitation, hovercraft, ground-effect, etc.), legged robots (e.g., power suits, single and multi-legged robots, etc.), space borne vehicles/robots, stationary robots that can either be retrieved or serviced in place, etc.

Maintenance that may be improved includes, but is not limited to, the following non-exhaustive list of things: Inspection, repair/rebuild/refurbish, cleaning, lubrication, preservation, recalibration, painting, refueling/recharging, restocking, detailing, valet parking robots (e.g., robotic car carrying robots that carry/tow cars to parking spaces, etc.), towing, tire changing, etc.

Services that may be performed by these vehicles/robots may include, but is not limited to: General trucking/teamster services, personal vehicles, subscription driving services, fleet services, vehicle convoys, swarming robots, common carrier services, rescue/ambulance services (e.g., improvements in maintenance and restocking), fire prevention services, law enforcement services, military services, governmental/municipal services (e.g., street sweeping, garbage collection, automobile pool, etc.), commercial services, disabled robot retrieval, food delivery, package/mail delivery, concierge autonomous travel (by land, sea, air, or space), valet parking (e.g., car carrying) services, Internet of Things (IoT) services (e.g., refrigerator or pantry could tell car to pick up some groceries, or other deliverable), educational/advertising robots, etc.

A “service provider” may be a human or a robot (i.e., a robot controlled either autonomously, semi-autonomously, through human supervisory control, tele-operation, manually, etc.).

The terms “robot” or “robotic” may include the following levels of control: Fully autonomous, semi-autonomous, human supervisory control, swarm, tele-operation, or in some cases, full manual control. “Robots” may also be controlled mobile or controlled stationary devices.

The invention may be performed in any computer associated with the operation of the invention. Further, it may be performed on a computer residing in the maintained robot, or a mobile computing device (such as a phone, tablet, laptop, etc.), stationary computer, cloud architecture, etc, or any combination thereof. Multiple computers may be “synched” together to perform the invention.” The invention may be operated through biometric interfaces (e.g., voice control of the invention, and/or locks operated by voice, fingerprint, retina, etc.).

In the context of this application, autonomous “agile scheduling” may include project management methods such as PERT, GANTT, Matroid, Kanban, SCRUM, etc. Maintenance appointments may be chained together for sequential, or parallel, or multiple appointments at different locations and maintainers before the robot returns home to resume service. For instance, a robot may go to one place for a tune up, another place for window repair, another for detailing, and finally return home.

The route followed by the robot may be optimized by any optimization method (e.g., the use of the “Traveling Salesman” algorithm to optimize the routes between maintainers). Further, the robot may be part of a convoy or swarm of robots that are scheduled to be maintained either simultaneously, serially, as needed, “just in time” (JIT), etc.

The scheduled appointments may also be set up to be recurring appointments that are automatically rescheduled on a recurring basis (e.g., rescheduling oil changes, or tune ups, or detailing services at regular intervals or based on a reasonable time interval after the previous service.) The user may optionally chain together the appointments for sequential, or parallel, or multiple performance before returning to the user.

Further, upon arrival at the maintenance location, the vehicle may be automatically guided to a parking spot to await maintenance, or may be guided automatically to a maintenance area, or may be carried or towed to a maintenance area via a valet parking robot. Garage doors may be automatically opened and closed accordingly.

Note that the vehicle may not have enough fuel, charge, or energy to complete its route. Therefore, the invention may check the route to determine if enough fuel (or energy) is onboard to complete the trip. If more fuel/energy is needed to complete the travel to or from the maintainer, a refueling stop may be automatically added to the route for automatic refueling. Alternatively, the user may be notified of the fuel/energy situation so that the user may go on a trip to manually add fuel/energy so that the vehicle may begin the trip when commanded. Further, before the return of the vehicle, it may be that the maintainer needs to be notified of the fuel situation so that the maintainer may refuel/recharge the vehicle for return (optionally, at additional cost). Further, during the return of the vehicle, the user may add an automatic refueling/recharging stop at the end of the return trip so that the vehicle is fully refueled (or recharged) upon return.

Also, the robot may return either automatically by itself, or may be guided by the user (who may have used and returned a loaner vehicle), or guided by an employee of the maintainer (who may use a loaner vehicle to return). Upon return, the robot may seek parking on its own or may seek assistance from the user or the owner of the lot.

The robot may use automated telemetry to discover, diagnose, and/or display on-board conditions that may need maintenance. For instance, automated recognition of types of problems that make noise or vibration (e.g., backfire, missing cylinder ignition, brake squeal, tires out of balance or misaligned, etc.). Also, such a system may monitor the response of a car to road bumps, which may indicate need for new shock absorbers (i.e., the shock absorber response is no longer critically damped and a threshold of performance out of specification may be defined).

The invention improves the field of robot maintenance by enabling a coordinated high throughput of vehicles through maintenance services without increasing manual labor costs. Further, it enables advertising, upselling, surge pricing, automated payments, and receipts through the invention. Further, refunds may be processed through the invention.

If theft of the robot is attempted, the invention may alert the user, alert the police, and/or lock driver in and drive to the police station. The invention may transmit photos and voices of occupants to the owner, to storage, and/or authorities. The invention may ask the user via phone, or computing device, or vehicle interface whether the detected user is authorized. The user may use a PIN, or password, or biometric, or physical token, or other authentication device to authenticate self and notify invention whether the occupant is authorized or not. The user interfaces may use text, voice, fingerprint, retina, etc.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

No claims in this application should be read to invoke 35 U.S.C. 112(F).

What is claimed is:

1. A method of providing maintenance and services for mobile or stationary robots comprising:
creating and maintaining at least one schedule database structure in which schedule data and other associated data is stored, partitioned, and secured via tools comprising zero or more of: Passwords, PINs, biometrics, tokens, or combinations thereof;
establishing a recommended maintenance and servicing schedule based on input data comprising one or more of: Manufacturer's recommended schedule, manufacturer's recalls, and other preferred maintenance and servicing schedules;
storing the recommended maintenance and servicing schedule in the schedule database structure;
establishing communication with the robot self-diagnostics to automatically or manually discover conditions that require maintenance;
establishing communication with the user, through a user interface and communications path to provide interface capabilities that permit the user to manage the scheduling data using management tasks comprising one or more of: Manually or automatically upload, update, and store the manufacturer's suggested maintenance tasks, manually or automatically upload, update, and store product recalls, manually or automatically upload, update, and store problems from the robot's self-diagnostics, manually or automatically upload, update, and store problems discovered by the user or maintainer, manually or automatically upload, update, and store problems discovered in any other way, and to manually or automatically upload, update, and store dates, times, and locations in the schedule database structure for the maintenance to actually occur;
presenting, through the user interface, suggestions for maintenance event locations produced from a user profile, which comprises one or more of: Lists of user preferences of maintainers for each task and a candidate list of local maintainers, where both lists additionally comprise zero, one, or more of: Advertisements of those businesses, their discounts, their ratings, and their presence on an automatic decline list that is maintained by the user;
upon selection or entry of one or a plurality of maintainers by the user, the invention sends to the maintainers service inquiries about service topics which comprise one or more of: Available locations, available services, available times, pricing, or other important issues and policies;
if there are responses from one or more maintainers, the responses are presented to the user so that zero, one, or a plurality of maintainers and actual appointment times are selected by the user;
if one or a plurality of maintainers is selected, the selected one or plurality of maintainers is notified that their response is accepted;
if there are maintainers that provided responses but the user declined the responses by selecting one or more responses from the list comprising: Assigning the particular service to another maintainer, actively declining the particular service, not accepting the particular service, or cancelling the particular service, the declined maintainers are automatically notified by the invention that their responses are not accepted;
if there are maintainers who did not provide responses before the user finally selected the maintainers that will perform the maintenance, the outstanding inquiries to the non-responsive providers are rescinded by the invention;
if there is a plurality of maintainer locations to be visited, thereby forming a schedule chain, the invention provides the user the option to optimize routes to each maintainer via travelling salesman or other route planning algorithm, while accounting for available appointment times, before finalizing selections of appointment times in the schedule chain;
appointment data comprising one or more of: Actual dates and times of the accepted appointments, locations of the one or plurality of maintainers, is manually or automatically recorded or updated in the schedule data structure;
the invention checks the robot's fuel, charge, or energy level to see if there is enough to complete a trip to the first maintainer;
if there isn't enough fuel, the invention notifies the user and schedules a refueling or recharging stop as the first maintenance in the schedule chain;
after each stop on the schedule chain, the invention further, checks the robot's fuel, charge, or energy level to see if there is enough complete a trip to the rest of the schedule chain, including the return trip; if there isn't enough fuel, the invention schedules a refueling or recharging stop as the next maintenance in the schedule chain;
if a robot is not capable of automatically departing on its own or being tele-robotically, or manually driven for any reason, the invention, upon approval of the user, either notifies a robot retrieval service to schedule transport of the robot to the maintenance appointment or notifies a mobile servicing unit to schedule delivery of service to the immobile robot;
the invention further comprises a communication path for further communication between the user and the robot retrieval service or mobile servicing unit, so that additional information is available for service, retrieval, or further assistance from police, fire, or ambulance services;
upon arrival of the robot at an appointment location, the invention notifies user and maintainer of the arrival;
upon reception of the robot by the maintainer using temporary authorizations, the maintainer is given authority to activate, repair, test, and drive the robot; a receipt documenting the reception event is produced and recorded for the user to keep in a file provided by the invention;
the invention provides to the maintainer a user interface where an estimate of the work to be done further comprising estimates regarding more maintenance work which is discovered, suggested, or upsold by the maintainer is made available to the user;
the user decides whether individual work tasks should be performed according to estimates;
If no work is to be performed, the schedule is set to release car to either go to the next appointment, if one is scheduled in an appointment chain, or to go to the return location assigned by the user;
If the user decides that any work tasks are to be performed according to the estimates, the user provides an affirmative response to some or all itemized maintenance tasks to be performed by the maintainer; for undesired tasks that are to be declined, the invention also asks the user to indicate that the undesired tasks are to be declined;
the user interface and communication path provided to the maintainer enables maintainer to set schedule data, partition the data, and secure the data in the schedule data structure, wherein the schedule data further comprises: The completion status of maintenance tasks, the time and date for releasing the robot to leave the maintainer (if maintainer decides to put lien on vehicle for payment, the time is set to an indefinite time);
if there is no lien on the vehicle and the vehicle is not in the process of repair, the user has the options to cancel or reschedule any or all appointments in the schedule data and to call for the vehicle to immediately return;
the invention notifies user of robot status data comprising one or more of: The current completion status of the maintenance tasks, the currently scheduled time for release of the robot and departure from the maintainer, the calculated time for arrival at the next destination;
at user's option, the robot's return location is set or updated to return to a place selected by the user, whether it is the user's home, workplace, phone's current GPS location, or any other user-selected location;
at one or more predetermined times before departure, robot notifies the user of Departure Data comprising one or more of: Notice that the robot is about to depart its current location, the next location, estimated time of arrival at the next location;
at scheduled departure time, the robot automatically departs to go to the one or more maintainers identified in its schedule chain and its progress is logged by the invention so that the robot status is tracked by the user by regularly updated GPS mapping or other interface;
if the robot is a stationary robot that needs to be transported back to its location, a robot transfer service is dispatched to replace the robot;
if the robot is a mobile robot, upon arrival at the next destination, the robot looks for available parking, notifies the user that it has arrived, and displays its location on map via GPS or other location service;
if vehicle has returned to the user and parking is not available, the invention notifies user of the fact and requests assistance or schedules a time and place to meet the user or to wait for the user.

2. The method of claim 1, further comprising: After creating and maintaining at least one schedule data structure, the invention creates and maintains at least one Agile scheduling module such as Kanban or SCRUM.

3. The method of claim 1, further comprising: After manually or automatically discovering conditions that require maintenance, the invention either automatically schedules a maintenance event or permits manual scheduling of a maintenance event, using the Agile scheduling module.

4. The method of claim 1, further comprising: After communicating to the user that maintenance is suggested and providing interface capabilities to permit the user to update the suggested maintenance tasks and to schedule dates and times for the maintenance to actually occur, updating the Agile scheduling module to reflect desired maintenance dates and times.

5. The method of claim 1, wherein pricing further comprises: Surge pricing.

6. The method of claim 1, further comprising: After inquiries are sent to maintainers as to available times, available services, and pricing, if there are no responses within a predetermined time, user is notified that there were no responses and that other maintainers should be selected or entered, or the maintenance should be delayed until a maintainer is available, or the user has the option to select communication with a human representative.

7. The method of claim 1, further comprising: After the responses are presented to the user so that a maintainer and actual appointment time is be selected by the user, the Agile scheduling module and the schedule data structure are updated using all relevant appointment data, upon user selection of a maintainer and appointment time.

8. The method of claim 1, further comprising: After the Agile scheduling module and the schedule data structure are updated using all relevant appointment data, the selected one or more maintainers is notified that their response is accepted, and the maintainer is also notified whether any offered loaner vehicle is accepted.

9. The method of claim 1, further comprising: After the selected one or more maintainers is notified that their response is accepted, and the maintainer is also notified whether any offered loaner vehicle is accepted, appointment data comprising actual date and time of the appointment, location of the maintainer, are recorded or updated in the schedule data structure, and Agile scheduling module.

10. The method of claim 1, further comprising: After the invention, optionally upon approval of the user, notifies a vehicle retrieval service to take the vehicle to the maintenance appointment and the invention automatically communicates the appointment data to the retrieval service if the robotic self-driving vehicle is capable of departing to the appointment on its own, the method comprises:
after said appointment data are recorded in the schedule data structure and Agile scheduling module, the invention calculates distance and travel time to the appointment and calculates appropriate departure time for prompt arrival;
at a predetermined amount of time ahead of departure time, the invention recalculates distance and travel time to the appointment to verify appropriate departure time for prompt arrival using updated data;
if there is no possibility of prompt arrival, the invention notifies the user that there is not enough time to arrive on time and allows user to either reschedule, cancel, or to go ahead and travel to appointment;
if prompt arrival is possible with the current traffic conditions, then, at a predetermined amount of time before actual vehicle departure, the user is notified that the vehicle is about to depart and gives user opportunity to cancel appointment and/or reschedule;
at the predetermined departure time, the vehicle to be maintained notifies the user of departure and departs for the maintenance appointment;
If a local obstacle, such as the user's garage door, impedes departure, the invention notifies the user of that status;
the owner's vehicle's progress to appointment is updated in the invention so the user and maintainer have data available to observe the tracked progress and provide the option to cancel the appointment during travel to maintainer;
if the appointment is cancelled during travel, the vehicle returns to original location or goes to user's current location if the location has changed during travel;
if the owner's vehicle breaks down en route and is no longer capable of going to the maintainer on its own, the invention calls a vehicle retrieval service to take the vehicle to the maintenance appointment and communicates the appointment data to the retrieval service and communicates its break down and retrieval service status to the user and the maintainer;
if a self-steering automated loaner vehicle has been requested by the user, the loaner vehicle is sent to user in order to replace the vehicle that will be repaired;
A photo of the loaner vehicle or one of similar make, model, and color is be sent to the user in order to aid in identification of the loaner vehicle when it arrives;
the loaner vehicle's travel progress is logged and made available for display to the user and the maintainer via user interfaces such as mapping modules.

11. The method of claim 1, further comprising: After the maintainer provides, through the invention, an estimate of the work to be done including more work that may be discovered by maintainer, either the user or maintainer updates the Agile scheduling module with any additional maintenance issues discovered.

12. The method of claim 1, further comprising: After the user provides an affirmative response to some or all itemized maintenance to be performed by the maintainer, once user affirms the work to be done, maintainer performs maintenance and updates the vehicle Agile schedule module that the appointment was completed;
upon arrival of the loaner vehicle at user's location, the invention notifies the user of the arrival;
the invention further configures the user's phone (or other computing device) to provide a user interface where the user has the option to operate the loaner car's lights and/or horn to provide further assistance in finding and identifying the loaner car;
the invention further configures the user's phone (or other computing device) to operate as a keyless entry device for the loaner vehicle;
the loaner vehicle is also started by commands from the phone or computing device.

13. The method of claim 1, where maintainer's setting of the vehicle return date and time in the vehicle schedule data structure further comprises: Setting the vehicle return date and time in the Agile schedule module.

14. The method of claim 1, wherein the invention provides to the customer an interface for rating the services provided by the at least one chosen maintainer.

15. The method of claim 1, wherein one or more interfaces use any combination of voice activation, fingerprint, retina, etc.

16. A computer readable medium with computer program steps for providing maintenance and services for mobile or stationary robots comprising:
creating and maintaining at least one schedule database structure in which schedule data and other associated data is stored, partitioned, and secured via tools comprising zero or more of: Passwords, PINs, biometrics, tokens, or combinations thereof;
establishing a recommended maintenance and servicing schedule based on input data comprising one or more of: Manufacturer's recommended schedule, manufacturer's recalls, and other preferred maintenance and servicing schedules;
storing the recommended maintenance and servicing schedule in the schedule database structure;
establishing communication with the robot self-diagnostics to automatically or manually discover conditions that require maintenance;
establishing communication with the user, through a user interface and communications path to provide interface capabilities that permit the user to manage the scheduling data using management tasks comprising one or more of: Manually or automatically upload, update, and store the manufacturer's suggested maintenance tasks, manually or automatically upload, update, and store product recalls, manually or automatically upload, update, and store problems from the robot's self-diagnostics, manually or automatically upload, update, and store problems discovered by the user or maintainer, manually or automatically upload, update, and store problems discovered in any other way, and to manually or automatically upload, update, and store dates, times, and locations in the schedule database structure for the maintenance to actually occur;
presenting, through the user interface, suggestions for maintenance event locations produced from a user profile, which comprises one or more of: Lists of user preferences of maintainers for each task and a candidate list of local maintainers, where both lists additionally comprise zero, one, or more of: Advertisements of those businesses, their discounts, their ratings, and their presence on an automatic decline list that is maintained by the user;
upon selection or entry of one or a plurality of maintainers by the user, the invention sends to the maintainers service inquiries about service topics which comprise one or more of: Available locations, available services, available times, pricing, or other important issues and policies;
if there are responses from one or more maintainers, the responses are presented to the user so that zero, one, or a plurality of maintainers and actual appointment times are selected by the user;
if one or a plurality of maintainers is selected, the selected one or plurality of maintainers is notified that their response is accepted;
if there are maintainers that provided responses but the user declined the responses by selecting one or more responses from the list comprising: Assigning the particular service to another maintainer, actively declining the particular service, not accepting the particular service, or cancelling the particular service, the declined maintainers are automatically notified by the invention that their responses are not accepted;
if there are maintainers who did not provide responses before the user finally selected the maintainers that will perform the maintenance, the outstanding inquiries to the non-responsive providers are rescinded by the invention;
if there is a plurality of maintainer locations to be visited, thereby forming a schedule chain, the invention provides the user the option to optimize routes to each maintainer via travelling salesman or other route planning algorithm, while accounting for available appointment times, before finalizing selections of appointment times in the schedule chain;
appointment data comprising one or more of: Actual dates and times of the accepted appointments, locations of the one or plurality of maintainers, is manually or automatically recorded or updated in the schedule data structure;
the invention checks the robot's fuel, charge, or energy level to see if there is enough to complete a trip to the first maintainer;
if there isn't enough fuel, the invention notifies the user and schedules a refueling or recharging stop as the first maintenance in the schedule chain;
after each stop on the schedule chain, the invention further, checks the robot's fuel, charge, or energy level to see if there is enough complete a trip to the rest of the schedule chain, including the return trip; if there isn't enough fuel, the invention schedules a refueling or recharging stop as the next maintenance in the schedule chain;
if a robot is not capable of automatically departing on its own or being tele-robotically, or manually driven for any reason, the invention, upon approval of the user, either notifies a robot retrieval service to schedule transport of the robot to the maintenance appointment or notifies a mobile servicing unit to schedule delivery of service to the immobile robot;
the invention further comprises a communication path for further communication between the user and the robot retrieval service or mobile servicing unit, so that additional information is available for service, retrieval, or further assistance from police, fire, or ambulance services;
upon arrival of the robot at an appointment location, the invention notifies user and maintainer of the arrival;
upon reception of the robot by the maintainer using temporary authorizations, the maintainer is given authority to activate, repair, test, and drive the robot; a receipt documenting the reception event is produced and recorded for the user to keep in a file provided by the invention;
the invention provides to the maintainer a user interface where an estimate of the work to be done further comprising estimates regarding more maintenance work which is discovered, suggested, or upsold by the maintainer is made available to the user;
the user decides whether individual work tasks should be performed according to estimates;
If no work is to be performed, the schedule is set to release car to either go to the next appointment, if one is scheduled in an appointment chain, or to go to the return location assigned by the user;
If the user decides that any work tasks are to be performed according to the estimates, the user provides an affirmative response to some or all itemized maintenance tasks to be performed by the maintainer; for undesired tasks that are to be declined, the invention also asks the user to indicate that the undesired tasks are to be declined;
the user interface and communication path provided to the maintainer enables maintainer to set schedule data, partition the data, and secure the data in the schedule data structure, wherein the schedule data further comprises: The completion status of maintenance tasks, the time and date for releasing the robot to leave the maintainer (if maintainer decides to put lien on vehicle for payment, the time is set to an indefinite time);
if there is no lien on the vehicle and the vehicle is not in the process of repair, the user has the options to cancel or reschedule any or all appointments in the schedule data and to call for the vehicle to immediately return;
the invention notifies user of robot status data comprising one or more of: The current completion status of the maintenance tasks, the currently scheduled time for release of the robot and departure from the maintainer, the calculated time for arrival at the next destination;
at user's option, the robot's return location is set or updated to return to a place selected by the user, whether it is the user's home, workplace, phone's current GPS location, or any other user-selected location;
at one or more predetermined times before departure, robot notifies the user of Departure Data comprising one or more of: Notice that the robot is about to depart its current location, the next location, estimated time of arrival at the next location;
at scheduled departure time, the robot automatically departs to go to the one or more maintainers identified in its schedule chain and its progress is logged by the invention so that the robot status is tracked by the user by regularly updated GPS mapping or other interface; if the robot is a stationary robot that needs to be transported back to its location, a robot transfer service is dispatched to replace the robot;
if the robot is a mobile robot, upon arrival at the next destination, the robot looks for available parking, notifies the user that it has arrived, and displays its location on map via GPS or other location service;
if vehicle has returned to the user and parking is not available, the invention notifies user of the fact and requests assistance or schedules a time and place to meet the user or to wait for the user.

17. An apparatus for providing maintenance and services for mobile or stationary robots comprising:
at least one schedule database module in which schedule data and other associated data is stored, partitioned, and secured via tools comprising zero or more of: Passwords, PINs, biometrics, tokens, or combinations thereof;
a recommended maintenance and servicing schedule storage module based on input data comprising one or more of: Manufacturer's recommended schedule, manufacturer's recalls, and other preferred maintenance and servicing schedules;
a storage module storing the recommended maintenance and servicing schedule in the schedule database structure;
a communication module for communicating with the robot self-diagnostics to automatically or manually discover conditions that require maintenance;
a communication module for communicating with the user, through a user interface and communications path to provide interface capabilities that permit the user to manage the scheduling data using management tasks comprising one or more of: Manually or automatically upload, update, and store the manufacturer's suggested maintenance tasks, manually or automatically upload, update, and store product recalls, manually or automatically upload, update, and store problems from the robot's self-diagnostics, manually or automatically upload, update, and store problems discovered by the user or maintainer, manually or automatically upload, update, and store problems discovered in any other way, and to manually or automatically upload, update, and store dates, times, and locations in the schedule database structure for the maintenance to actually occur;
a user interface module for presenting suggestions for maintenance event locations produced from a user profile, which comprises one or more of: Lists of user preferences of maintainers for each task and a candidate list of local maintainers, where both lists additionally comprise zero, one, or more of: Advertisements of those businesses, their discounts, their ratings, and their presence on an automatic decline list that is maintained by the user;
a program execution module that executes steps comprising:
upon selection or entry of one or a plurality of maintainers by the user, the invention sends to the maintainers service inquiries about service topics which comprise one or more of: Available locations, available services, available times, pricing, or other important issues and policies;
if there are responses from one or more maintainers, the responses are presented to the user so that zero, one, or a plurality of maintainers and actual appointment times are selected by the user;
if one or a plurality of maintainers is selected, the selected one or plurality of maintainers is notified that their response is accepted;
if there are maintainers that provided responses but the user declined the responses by selecting one or more responses from the list comprising: Assigning the particular service to another maintainer, actively declining the particular service, not accepting the particular service, or cancelling the particular service, the declined maintainers are automatically notified by the invention that their responses are not accepted;
if there are maintainers who did not provide responses before the user finally selected the maintainers that will perform the maintenance, the outstanding inquiries to the non-responsive providers are rescinded by the invention;
if there is a plurality of maintainer locations to be visited, thereby forming a schedule chain, the invention provides the user the option to optimize routes to each maintainer via travelling salesman or other route planning algorithm, while accounting for available appointment times, before finalizing selections of appointment times in the schedule chain;
a schedule data module where appointment data comprising one or more of: Actual dates and times of the accepted appointments, locations of the one or plurality of maintainers, is manually or automatically recorded or updated in the schedule data structure;
program execution module that further executes steps comprising:
the invention checks the robot's fuel, charge, or energy level to see if there is enough to complete a trip to the first maintainer;
if there isn't enough fuel, the invention notifies the user and schedules a refueling or recharging stop as the first maintenance in the schedule chain;
after each stop on the schedule chain, the invention further, checks the robot's fuel, charge, or energy level to see if there is enough complete a trip to the rest of the schedule chain, including the return trip; if there isn't enough fuel, the invention schedules a refueling or recharging stop as the next maintenance in the schedule chain;
if a robot is not capable of automatically departing on its own or being tele-robotically, or manually driven for any reason, the invention, upon approval of the user, either notifies a robot retrieval service to schedule transport of the robot to the maintenance appointment or notifies a mobile servicing unit to schedule delivery of service to the immobile robot;
further comprising a communication path for further communication between the user and the robot retrieval service or mobile servicing unit, so that additional information is available for service, retrieval, or further assistance from police, fire, or ambulance services;
upon arrival of the robot at an appointment location, the invention notifies user and maintainer of the arrival;
upon reception of the robot by the maintainer using temporary authorizations, the maintainer is given authority to activate, repair, test, and drive the robot; a receipt documenting the reception event is produced and recorded for the user to keep in a file provided by the invention;
the invention provides to the maintainer a user interface where an estimate of the work to be done further comprising estimates regarding more maintenance work which is discovered, suggested, or upsold by the maintainer is made available to the user;
a user interface module that permits the user to communicate with the program execution module to decide whether individual work tasks should be performed according to estimates;
program execution module that further executes steps comprising:
If no work is to be performed, the schedule is set to release car to either go to the next appointment, if one is scheduled in an appointment chain, or to go to the return location assigned by the user;
If the user decides that any work tasks are to be performed according to the estimates, the user provides an affirmative response to some or all itemized maintenance tasks to be performed by the maintainer; for undesired tasks that are to be declined, the invention also asks the user to indicate that the undesired tasks are to be declined;
a user interface module and communication path module provided to the maintainer that enables maintainer to set schedule data, partition the data, and secure the data in the schedule data structure, wherein the schedule data further comprises: The completion status of maintenance tasks, the time and date for releasing the robot to leave the maintainer (if maintainer decides to put lien on vehicle for payment, the time is set to an indefinite time);
program execution module that further executes steps comprising:
if there is no lien on the vehicle and the vehicle is not in the process of repair, the user has the options to cancel or reschedule any or all appointments in the schedule data and to call for the vehicle to immediately return;
the invention notifies user of robot status data comprising one or more of: The current completion status of the maintenance tasks, the currently scheduled time for release of the robot and departure from the maintainer, the calculated time for arrival at the next destination;
at user's option, the robot's return location is set or updated to return to a place selected by the user, whether it is the user's home, workplace, phone's current GPS location, or any other user-selected location;
at one or more predetermined times before departure, robot notifies the user of Departure Data comprising one or more of: Notice that the robot is about to depart its current location, the next location, estimated time of arrival at the next location;
at scheduled departure time, the robot automatically departs to go to the one or more maintainers identified in its schedule chain and its progress is logged by the invention so that the robot status is tracked by the user by regularly updated GPS mapping or other interface;
if the robot is a stationary robot that needs to be transported back to its location, a robot transfer service is dispatched to replace the robot;
if the robot is a mobile robot, upon arrival at the next destination, the robot looks for available parking, notifies the user that it has arrived, and displays its location on map via GPS or other location service;
if vehicle has returned to the user and parking is not available, the invention notifies user of the fact and requests assistance or schedules a time and place to meet the user or to wait for the user.
